(19) United States
(12) Patent Application Publication
(10) Pub. No.: US 2014/0090835 A1
(43) Pub. Date: Apr. 3, 2014

(54) SYSTEMS AND METHODS FOR THE DETERMINATION OF GAS PERMEABILITY

(71) Applicant: CORE LABORATORIES LP, Houston, TX (US)

(72) Inventor: Ted J. Griffin, JR., Spring, TX (US)

(73) Assignee: Core Laboratories LP, Houston, TX (US)

(21) Appl. No.: 13/631,007

(22) Filed: Sep. 28, 2012

(51) Int. Cl. G01N 15/08; E21B 47/06

(52) U.S. Cl. 166/250.01; 73/38

(57) ABSTRACT

According to various embodiments, a method may include supplying a gas to an upstream side of a core holder containing a core sample, accumulating permeated gas that has flowed through the core sample in a cavity coupled to a downstream side of the core holder, measuring an elapsed time during which the permeated gas accumulates in the cavity using a timer, measuring a pressure of the permeated gas using a pressure transducer coupled to the cavity, and determining a gas permeability of the core sample based at least in part on the pressure of the permeated gas and the elapsed time.

### BACKGROUND

The present disclosure relates generally to permeability measurement and, more particularly, to determining the gas permeability of core samples.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Petroleum, or crude oil, is a flammable liquid that includes a mixture of various compounds, such as hydrocarbons and other organic compounds, and occurs naturally in subsurface formations. Natural gas is a flammable gas that may also occur naturally in subsurface formations or may be together with petroleum and other hydrocarbon fuels. Petroleum may have been formed by the exposure of ancient organic material that settled onto lake or sea bottoms to intense heat and/or pressure. Today, wells drilled into subsurface formations associated with these ancient bodies of water may be used to recover the petroleum. The underground pressure found in some formations may be sufficient to force the petroleum to the surface. In other formations, more expensive techniques, referred to as secondary and tertiary methods, may be used to bring the petroleum to the drilled shaft, or wellbore. The recovered petroleum from the wellbore may be separated via distillation into a variety of liquid and gaseous products, such as gasoline, kerosene, propane, and asphalt, and chemical intermediates used in the manufacture of consumer products, such as plastics and pharmaceuticals. Unfortunately, global petroleum reserves have been declining as worldwide consumption of petroleum products continues to increase. In addition, the costs associated with petroleum recovery have increased as more secondary and tertiary methods are used to recover the dwindling supplies of petroleum. These rising costs are reflected in the increased cost of fuels and other consumer products.

In light of its limited future, producers have sought out alternatives to conventional petroleum resources. Such alternatives may include unconventional resources, such as shale oil or shale gas reservoirs. Shale oil may be recovered using methods similar to those used for petroleum recovery. For example, wells may be drilled into shale oil deposits and various techniques, such as hydraulic fracturing or other stimulation, may be used to recover the shale oil. Shale oil and shale gas may be used successfully as fuels or chemical intermediates. Thus, the development of shale oil deposits may be expected to increase as worldwide supplies of petroleum and other hydrocarbons decrease, and current estimates of global shale oil deposits exceed those of petroleum.

Although hydrocarbon deposits may be found in many parts of the world, these deposits vary widely in their organic compound content and other characteristics. Thus, for commercial and economic reasons, producers may prefer to develop hydrocarbon deposits from which the hydrocarbons may be removed more easily. Surface-based methods, such as seismic studies that involve sending sound waves into the ground and analyzing their reflections, may be used to identify potential hydrocarbon deposits. Subsequently, drilling may be used to physically obtain samples from the subsurface formations. These samples, referred to as core samples or simply cores, may be sent to laboratories or other facilities for analysis. Various tests of the core samples may be conducted to estimate the content of organic material in the hydrocarbon deposit and other characteristics of the hydrocarbon deposit. For example, the permeability of the core sample may indicate the ease by which the hydrocarbons may be obtained from the subsurface formation. Specifically, permeability is a property of a porous medium and is a measure of its ability to transmit a fluid. In other words, the measurement of permeability of a porous core sample is a measurement of the fluid conductivity of the particular material. Thus, permeability is the fluid-flow analog of electrical or thermal conductivity. The ability of a porous material to allow a gas to pass though it may be referred to as its gas permeability and the ability of the porous material to allow a liquid to pass though it may be referred to as its liquid permeability.

There are several methods for determining the permeability of core samples. For example, a gas or liquid may flow through the core sample under steady-state or unsteady-state (transient) conditions. Such methods may be referred to as direct measurements of permeability. Such direct measurements may have several limitations. For example, certain direct measurements may be limited to core samples with relatively high gas permeabilities, thereby making such methods unsuitable for shale reservoirs that have relatively low gas permeabilities. Specifically, such methods may be effective only down to approximately 0.01 millidarcys (md). However, tight gas reservoirs may have gas permeabilities between approximately 0.0001 to 0.01 md. Shale reservoirs may have gas permeabilities even lower than tight gas reservoirs. For example, certain shale reservoirs may have gas permeabilities measured in the nanodarcy (i.e., 1×10⁻⁶ md) to picodarcy (i.e., 1×10⁻⁹ md) range. In addition, existing direct measurement methods use complicated mathematical formulas and correlations that may make determination of the permeability difficult, time-consuming, and more subject to error. Other direct measurement methods may be labor-intensive, have high operating costs, capital costs, and core sample cleaning and preparation costs, and/or require multiple measurements, high-pressure, leak-tight systems, difficult core sample preparation, and corrosion resistant and other expensive equipment. Various indirect methods may also be used to infer the permeability of a core sample from empirical correlations. However, such indirect methods may be less accurate and more time-consuming than direct measurements.

Thus, current techniques for determining the permeability of a core sample possess several shortcomings. Accordingly, there exists a need for techniques for determining permeabilities of core samples from shale reservoirs and other types of tight gas reservoirs quickly, simply, accurately, and inexpensively.

### BRIEF DESCRIPTION OF THE DRAWINGS

Advantages of the disclosed techniques may become apparent upon reading the following detailed description and upon reference to the drawings in which:

FIG. 1 is a block diagram of an embodiment of a hydrocarbon production system that includes core sampling;

FIG. 2 is a work flow chart of a process for using a core sample permeability system to determine a gas permeability of a core sample in accordance with an embodiment of the present technique;

FIG. 3 is a work flow chart of a process for determining a gas permeability of a core sample in accordance with an embodiment of the present technique;

FIG. 4 is a schematic diagram of an embodiment of a gas permeability measurement system; and

FIG. 5 is a side view of a flowmeter assembly that may be used with the gas permeability measurement system of FIG. 4.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Techniques for determining permeabilities of subsurface samples from tight gas reservoirs and/or shale reservoirs are disclosed herein. Subsurface samples include, but are not limited to, cores, core samples, core plugs, drill cuttings, powders, and so forth. In one embodiment, a gas is supplied to an upstream side of a core holder containing the subsurface sample. Next, the permeated gas that has flowed through the subsurface sample may be accumulated in a cavity coupled to a downstream side of the core holder. A timer may be used to measure an elapsed time during which the permeated gas accumulates in the cavity. In addition, a pressure transducer coupled to the cavity may be used to measure a pressure of the permeated gas. Finally, the gas permeability of the subsurface sample may be determined based at least in part on the pressure of the permeated gas and the elapsed time. In certain embodiments, an oral, digital, or physical report may be generated that includes the determined gas permeability. The disclosed techniques for determining the gas permeability of subsurface samples may be implemented in a variety of ways. For example, in one embodiment, one or more steps may be performed automatically and one or more steps may be performed manually. In another embodiment, all of the steps may be performed automatically, such as by a single stand-alone system. In yet another embodiment, measurement values may be transmitted to a computer, which is programmed with instructions for determining the gas permeability of the subsurface sample. The gas permeability may then be displayed on a monitor connected to the computer. For example, the measurement data may be collected at a wellsite and transmitted to a vehicle or other facility where the computer determines the gas permeability.

The techniques described in detail below may possess several advantages compared to previous methods for determining the permeability of subsurface samples. For example, the disclosed techniques may be ideally suited for determining the gas permeability of tight gas reservoirs and/or shale reservoirs. In other words, a relatively small accumulation of the permeated gas in the cavity is used to determine the gas permeability. In addition, the use of the pressure transducer in the disclosed techniques may enable the permeability to be determined more accurately than in other methods using manual or other less accurate techniques. Further, the disclosed techniques may be relatively simple to perform because of the use of equations based on the ideal gas law to determine the gas permeability. Moreover, the disclosed techniques may be ideally suited for automation.

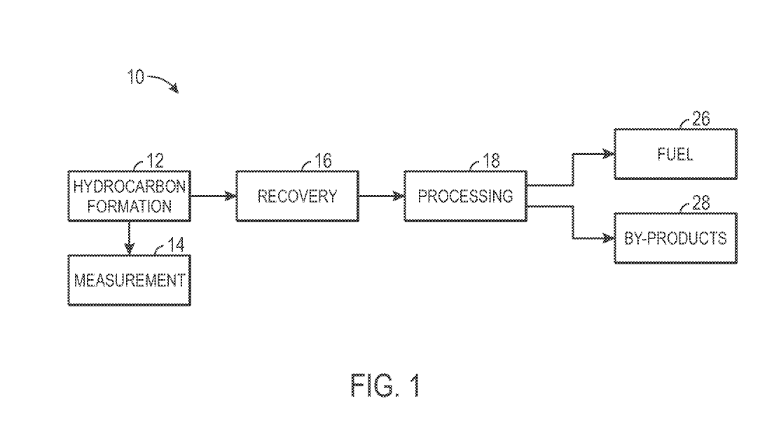

With the foregoing in mind, FIG. 1 is a block diagram of a hydrocarbon production process 10 in accordance with an embodiment. As illustrated, a hydrocarbon subsurface formation 12 is first identified using a variety of methods such as, but not limited to, geological surveys, core sampling, test wells, seismic studies, and so forth. For example, measurement 14 of subsurface samples from the subsurface formation 12 using the techniques described in detail below may be conducted to identify the gas permeability of the subsurface formation 12. In particular, a variety of common drilling techniques may be used to obtain the subsurface sample from the subsurface formation 12. In certain embodiments, the permeability of the subsurface sample may be used to determine the ease by which hydrocarbons may be obtained from the subsurface formation 12. Examples of subsurface formations 12 include, but are not limited to, sandstone formations, limestone formations, shale oil formations, shale gas formations, and so forth.

Permeability may be defined as a measure of the ability of a porous material to allow fluids to pass through it. For example, a low permeability may indicate a material that allows little fluid to pass through it. Permeability to gases may be somewhat different than permeability to liquids for the same material. This difference may be attributable to “slippage” of gas at the interface with the solid. Thus, gas permeability may refer to the ability of the porous material to allow gases to pass through it and liquid permeability may refer to the ability of the porous material to allow liquids to pass through it. Subsurface samples with higher permeabilities may indicate formations from which hydrocarbons may be removed more easily or with less use of advanced recovery techniques, such as hydraulic fracturing.

Measurement 14 of the subsurface formation 12 may continue until one or more locations to begin hydrocarbon production have been identified. After a subsurface formation 12 that can be economically produced is identified, recovery 16 of the hydrocarbons may be performed. For example, various drilling and recovery techniques may be used to bring the hydrocarbons to the surface. Once the hydrocarbons are recovered from the subsurface formation 12, the hydrocarbons may be processed in a processing system 18 to produce refined hydrocarbons suitable for use as a fuel 26 and/or byproducts 28. For example, the fuel 26 may be combusted to produce heat and energy in a variety of combustors, reactors, or engines. The byproducts 28 may be used as raw materials in a variety of chemical, pharmaceutical, and many other industries.

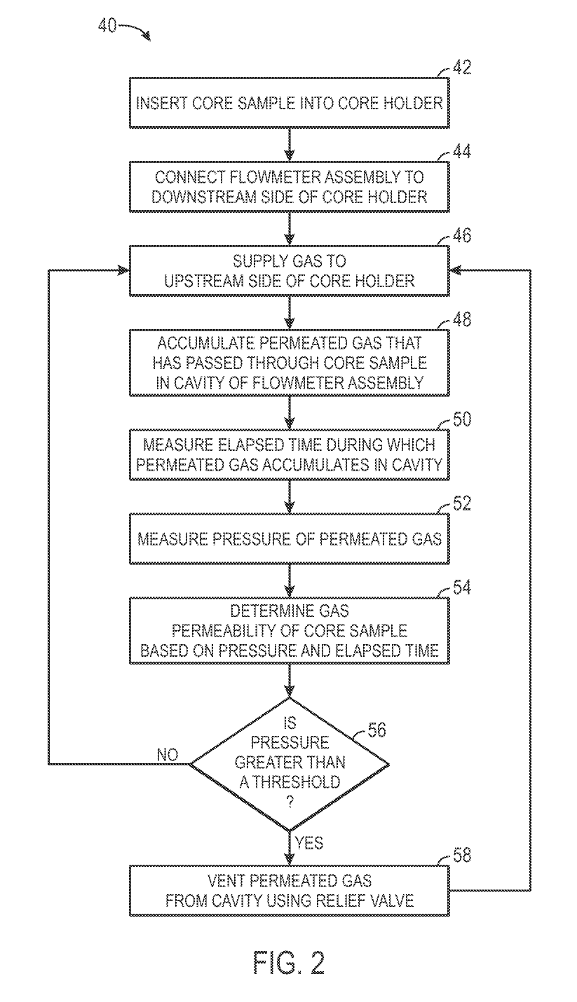

The techniques described below may be used during the hydrocarbon production process 10 of FIG. 1 to quickly and accurately determine the gas permeability of subsurface samples from the subsurface formation 12. The use of such techniques may be expected to increase as worldwide petroleum reserves decrease and producers turn to petroleum alternatives, such as shale oil and shale gas. Specifically, FIG. 2 is a work flow chart of a process 40 for determining gas permeabilities of subsurface samples, such as core samples, using a gas permeability measurement system. In a first step 42, a core sample is inserted into a core holder, which may be a hollow cylindrical metal tube. The physical characteristics of the core holder are described in detail below. In a second step 44, a flowmeter assembly is connected to a downstream side of the core holder. As described in detail below, the flowmeter assembly receives permeated gas that has flowed through the core sample. In a third step 46, a gas is supplied to an upstream side of the core holder. Various gases may be used for permeability measurement such as, but not limited to, air, nitrogen, helium, methane, and so forth. The gas may be supplied to the upstream side of the core holder at an elevated pressure, such as at a pressure greater than approximately 35 psi. The particular upstream pressure selected may be based on the expected permeability of the core sample. For example, a higher pressure of the gas may be used with core samples with relatively low permeabilities.

The gas supplied to the upstream side of the core holder slowly flows through the core sample. In a fourth step 48, the permeated gas that has passed through the core sample accumulates in a cavity of the flowmeter assembly. The core holder may be configured such that only permeated gas that has flowed though the core sample accumulates in the cavity. In other words, the core holder is configured to help prevent the gas from bypassing the core sample into the cavity. In a fifth step 50, the elapsed time during which the permeated gas accumulates in the cavity is measured. For example, a timer configured to start when the gas is supplied to the upstream side of the core holder may be used to measure the elapsed time. In a sixth step 52, the pressure of the permeated gas in the cavity is measured. For example, a pressure transducer may be used to measure the pressure of the cavity. As described in detail below, the pressure transducer may be selected to provide good accuracy at low pressures. In a seventh step 54, the gas permeability of the core sample is determined based at least in part on the measured pressure and elapsed time from the fifth and sixth steps 50 and 52. Examples of specific steps and equations that may be used to determine the gas permeability in the seventh step 54 are described in detail below.

In an eighth step 56, the measured pressure is compared with a threshold pressure. If the measured pressure is less than the threshold, the process 40 continues to the third step 46 to supply additional gas to the upstream side of the core holder. However, if the measured pressure is greater than the threshold pressure, the process 40 continues to a ninth step 58, in which the permeated gas is vented from the cavity using a device such as a relief valve. A maximum pressure rating of the cavity may be used to determine the value of the pressure threshold to help prevent overpressure of the cavity. After the permeated gas is vented in the ninth step 58, the process 90 may continue to the third step 46 to supply additional gas to the upstream side of the core holder. Thus, the process 90 may be used to obtain a plurality of gas permeability measurements of the core sample, which may provide a more accurate value of the gas permeability than a single measurement. For example, several measurements may be averaged together or certain values obtained toward the beginning or end of the process 90 may be ignored. After the permeated gas has been vented from the cavity in the ninth step 58 or after a desired number of gas permeability measurements have been obtained, the core sample may be removed from the core holder and additional gas permeability measurements obtained for other core samples. The process 40 may be described as a steady-state process because a continuous supply of gas is provided to the upstream side of the core sample during testing, thereby producing a steady or approximately constant flow rate of permeated gas through the core sample. This is different from an unsteady-state process in which a finite quantity of gas is supplied to the core sample initially, thereby resulting in a decreasing flow rate of permeated gas that eventually ceases completely.

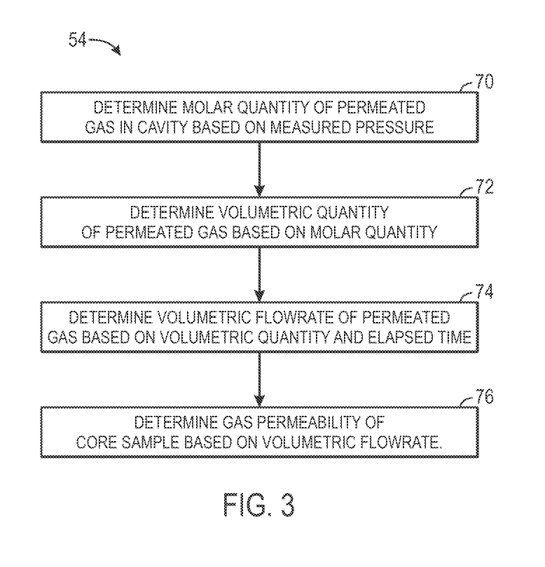

With the process 40 for using the permeability measurement system in mind, FIG. 3 is a flow chart of the process 54 for obtaining the gas permeability of the core sample using the measured elapsed time and pressure. In a first step 70, the molar quantity of permeated gas in the cavity is determined using the following equation:

$$n = \frac{P \cdot V}{R \cdot T} \qquad ( EQUATION 1 )$$

where n is the molar quantity, P is the pressure, R is an ideal gas constant, and T is a temperature of the permeated gas. The molar quantity n represents the number of moles of the permeated gas present in the cavity based on the ideal gas law. The pressure P is the pressure of the cavity as measured by the pressure transducer. The selected value of the ideal gas constant R is based on the units of measurement used in the other variables of Equation 1. For example, the ideal gas constant R may equal approximately 8.314 J/K·mol or 1.986 Btu/lb-mol·R. The temperature T may be measured using a temperature probe inserted into the cavity. Next, in a second step 72, the volumetric quantity of the permeated gas at a specific pressure condition is determined using the following equation:

$${V}_{m} = \frac{n \cdot R \cdot T}{{P}_{m}} \qquad ( EQUATION 2 )$$

where Vₘ is the volumetric quantity, n is the molar quantity, R is the ideal gas constant, T is the temperature of the permeated gas, and Pₘ is a mean gas pressure. The mean gas pressure Pₘ (i.e., the specific pressure condition) is determined using the following equation:

$${P}_{m} = \frac{{P}_{1} + {P}_{2}}{2} \qquad ( EQUATION 3 )$$

where Pₘ is the mean gas pressure, P₁ is a supplied pressure of the gas upstream of the core holder, and P₂ is a downstream pressure of the gas downstream of the core holder. the pressure of the cavity. The supplied pressure P₁ may be determined using a pressure gage or sensor coupled to the gas supply upstream of the core holder. Likewise, the downstream pressure P₂ may be determined using a pressure gage or sensor coupled downstream of the core holder. In certain embodiments, the downstream pressure P₂ may be the same as the cavity pressure P. For example, the reading of the pressure transducer coupled to the cavity may be used for both the downstream pressure P₂ and the cavity pressure P. In other embodiments, the downstream pressure P₂ may be different from the cavity pressure P. For example, a separate pressure sensor disposed downstream of the core holder and upstream of the cavity may be used to provide the downstream pressure P₂. As this separate pressure sensor is upstream of the pressure transducer coupled to the cavity, the value of the downstream pressure P₂ may be slightly greater than the cavity pressure P because of the pressure drop of the flowing permeated gas. The volumetric quantity Vₘ represents the volume of the permeated gas at the mean gas pressure Pₘ based on the ideal gas law. Thus, the volumetric quantity Vₘ is generally not the same as the volume of the cavity because the mean gas pressure Pₘ is not the same as the downstream pressure P₂ or the cavity pressure P.

Next, in a third step 74, the volumetric flow rate of the permeated gas is determined using the following equation:

$$Q = \frac{{V}_{m}}{t} \qquad ( EQUATION 4 )$$

where Q is the volumetric flow rate, Vₘ is the volumetric quantity, and t is the elapsed time. As discussed above, a timer may be used to measure the elapsed time t. The volumetric flow rate Q represents the flow rate of the gas through the core sample. Next, in a fourth step 76, the gas permeability is determined using the following equation:

$${K}_{gas} = \frac{Q \cdot μ \cdot L \cdot {P}_{a} \cdot 2}{A \cdot ( {P}_{1} - {P}_{2} ) \cdot ( {P}_{1} + {P}_{2} )} \qquad ( EQUATION 5 )$$

where K_{gas} is the gas permeability, Q is the volumetric flow rate, μ is a viscosity of the gas, L is a length of the core sample, Pₐ is an atmospheric pressure, A is a cross-sectional area of the core sample, P₁ is the supplied pressure, and P is the pressure. Equation 5 represents a linear form of Darcy's Law, which describes the flow of a fluid through a porous medium. The viscosity μ of the gas may be obtained from standard tables of physical properties, physical property simulation software, estimates, or direct measurement. The atmospheric pressure Pₐ corresponds to the local atmospheric pressure of the gas permeability measurement system. The length L and cross-sectional area A of the core sample may be determined by physically measuring the core sample. As described above, the gas permeability K_{gas} represents the ability of the core sample to allow a gas to pass through it. In certain embodiments, Equation 5 may include an additional numerical term to account for different units of measure used in the variables of the equation. For example, when the units of md, cm³/sec, centipoise, cm, atmosphere, cm², atmosphere, and atmosphere are used for the variables K_{gas}, Q, μ, L, Pₐ, A, P₁, and P₂, respectively, the numerator of Equation 5 includes the numerical value of 1000.

As shown above, the various equations used in the process 54 for determining the gas permeability K_{gas} of core samples are relatively simple and straightforward to use. However, the equations may be executed by a computing device, as described below, to enable calculations to be quickly and accurately performed for a plurality of different pressures P for a single core sample or for several different core samples. In addition, the process 54 utilizes values provided by the gas permeability measurement system, well-known constants, and easily-obtained physical property data. Thus, the process 54 does not involve the use of complicated equations, correlations, estimations, and/or iterative calculations that may be characteristic of other methods of determining gas permeability. In addition, although the process 54 is described as a sequence of four steps above, in other embodiments, two or more of the steps may be combined. For example, Equation 1 may be directly substituted for the molar quantity n in Equation 2. Thus, the process 54 may be performed in less than four steps in certain embodiments, thereby further simplifying the process 54.

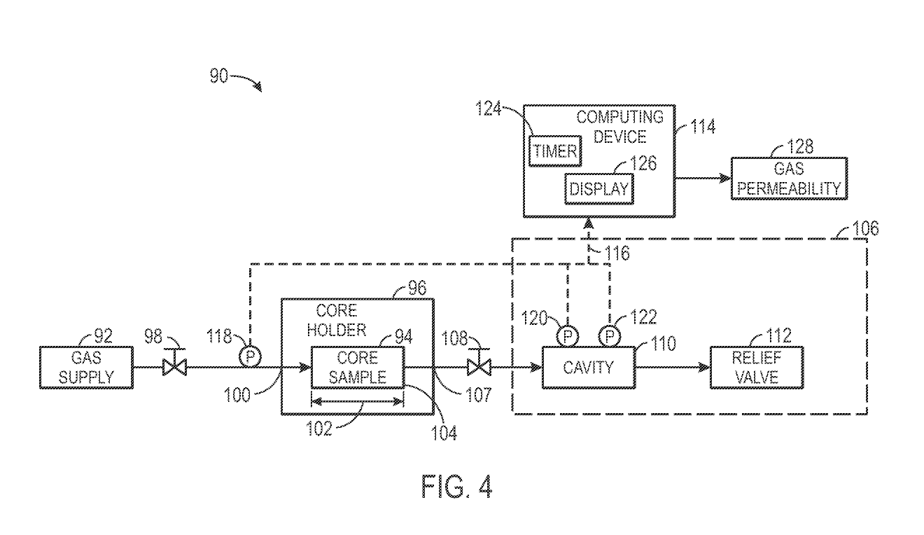

Different systems may be used to perform the techniques for determining the gas permeability of subsurface samples described above. For example, in one embodiment, certain steps of the disclosed techniques may be performed automatically and other steps performed manually. In another embodiment, a computer may determine and display the gas permeability of the subsurface sample based on measurement values transmitted to the computer. In the embodiment shown in FIG. 4, a permeability measurement system 90 may be used to perform one or more of the steps associated with the process 40. In certain embodiments, the permeability measurement system 90 may perform one or more of the steps associated with the process 54 automatically. In the illustrated embodiment, the permeability measurement system 90 includes a gas supply 92 to provide the gas to a core sample 94 disposed within a core holder 96. Examples of gases that may be provided by the gas supply 92 include, but are not limited to, air, nitrogen, helium, methane, and so forth. Although shown in a horizontal arrangement in FIG. 4, the core holder 96 and core sample 94 may be arranged vertically or at any other angle during testing. In certain embodiments, a gas supply valve 98 may be used to start, adjust, and/or stop a flow rate of the gas from the gas supply 92 to an upstream side 100 of the core holder 96. The core sample 94 may be defined by a length 102 and a cross-sectional area 104. As discussed above, the length 102 and the cross sectional area 104 may be used in the determination of the gas permeability in the process 54. In certain embodiments, the shape and/or dimensions of the core sample 94 may be standardized. For example, in certain embodiments, the core sample 94 may have a circular cross-section and a diameter of approximately 1 inch. Thus, the cross-sectional area 104 may be approximately 0.785 square inches. The core holder 96 may be made from any material compatible with the core sample 94 and the gas supply 92. Specifically, the core holder 96 may be made from a metal or metal alloy with an appropriate thickness to be used at the pressure of the gas supply 92.

As shown in FIG. 4, a flowmeter assembly 106 may be coupled to a downstream side 107 of the core holder 96. In certain embodiments, a downstream valve 108 may be used to allow the permeated gas from the core holder 96 to be admitted to the flowmeter assembly 106 when the downstream valve 108 is open. In other words, the downstream valve 108 may be opened to begin the gas permeability measurement. The flowmeter assembly 106 includes a cavity 110 in which the permeated gas may accumulate. The cavity 110 may be made from any material compatible with the gas and made to withstand a pressure of at least that of the gas supply 92. In addition, a volume of the cavity 110 may be selected to enable accurate determination of the gas permeability using the techniques described above. For example, selecting a smaller volume for the cavity 110 may enable the pressure of the permeated gas to increase faster, thereby reducing the time for the gas permeability measurement. In addition, a relief valve 112 may be coupled to the cavity 110 and configured to open when a threshold pressure within the cavity 110 is reached. Thus, the relief valve 112 may help protect the cavity 110 from being overpressured. In addition, the relief valve 112 may be used to depressurize the cavity 110 when the gas permeability testing for a particular core sample 94 is complete. In other embodiments, a separate vent valve may be used to vent the cavity 110.

In addition to the physical components of the permeability measurement system 90 associated with the core holder 96, a computing device 114 may be used to determine the gas permeability of the core sample 94. Specifically, the computing device 114 may receive various input signals 116 from sensors disposed within the permeability measurement system 90. For example, the computing device 114 may receive the input signal 116 from a gas supply pressure sensor 118, a cavity pressure sensor 120, a cavity temperature sensor 122, and so forth. The sensors 118, 120, and 122 may provide the various values used in the equations of the process 54 described in detail above to determine the gas permeability. In certain embodiments, the computing device 114 may include a timer 124 to measure the elapsed time during which the permeated gas accumulates in the cavity 110. For example, the timer 124 may start when the downstream valve 108 is opened. In other embodiments, a timer 124 physically separate from the computing device 114 may provide input signals 116 to the computing device 114 representative of the elapsed time. In further embodiments, the computing device 114 may include a display 126, which may be used to show the obtained gas permeability of the core sample 94. In addition, the display 126 may show other relevant information associated with the determination of the gas permeability. As the computing device 114 receives the information from the sensors 118, 120, and 122, the computing device 114 may automatically perform the steps of the process 54 and then display the calculated gas permeability of the core sample 94 on the display 126. The display 126 may also show a plurality of gas permeability values in a tabular or graphical format. In addition, the computing device 114 may provide a physical report of the gas permeability 128, either by itself or though a connected printer. After the completion of the gas permeability measurements, the core sample 94 may be removed from the core holder 96 to enable testing of additional core samples 94 by repeating the steps of the process 40. In certain embodiments, the permeability measurement system 90 may be configured differently from that shown in FIG. 4.

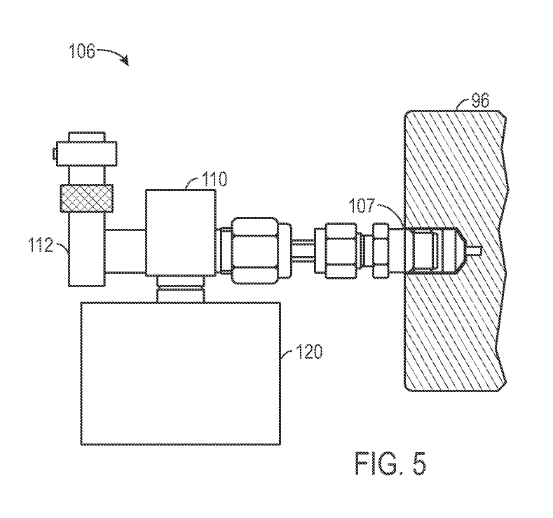

FIG. 5 is a side view of one possible arrangement of the flowmeter assembly 106 shown in FIG. 4. Elements in common with those shown in FIG. 4 are labeled with the same reference numerals. Specifically, the flowmeter assembly 106 is coupled to the downstream side 107 of the core holder 96 via a threaded connection, which may help provide a leak proof connection. Tubing and/or additional fittings may be used to connect the cavity 110 to the downstream side 107. The volume of the cavity 110 may be relatively small in order to be used in the determination of gas permeabilities for tight reservoirs, such as shale reservoirs. For example, in certain embodiments, the volume of the cavity 110 may be less than approximately 0.5 cc³. The relief valve 112 and the pressure transducer 120 may be coupled directly to the cavity 110. As discussed above, because of the low gas permeabilities associated with core samples 94 obtained from shale reservoirs, the pressures reached in the cavity 110 during the process 40 may be relatively low. Thus, in certain embodiments, the pressure transducer 120 may be selected to provide accurate pressure measurements at pressures below approximately 1.2 kilopascals. Such pressure transducers 120 would not typically be used with prior methods for determining gas permeability. As shown in FIG. 5, the distance between the cavity 110 and the downstream side 107 may be reduced to help improve the accuracy of the gas permeability measurement. Although not shown in FIG. 5, the pressure sensor 120 may be coupled to the computing device 114 via an electrical connection, such as a wire or cable.

Certain embodiments of the permeability measurement system 90 may include computer-implemented processes and apparatuses for practicing those processes. For example, some embodiments may include a computer program product having computer program code containing executable instructions embodied in non-transitory tangible, machine-readable media, such as floppy diskettes, CD-ROMs, hard drives, USB (universal serial bus) drives, or any other tangible computer readable storage medium, wherein, when the computer program code is loaded into and executed by a computer, the computer becomes an apparatus for practicing embodiments of present techniques. Certain embodiments may include computer program code, for example, whether stored in a storage medium or loaded into and/or executed by a computer, wherein when the computer program code is stored in and executed by a computer, the computer becomes an apparatus for practicing embodiments of present techniques. When implemented on a general-purpose processor, the computer program code segments configure the processor to create specific logic circuits. Specifically, the permeability measurement system 90 may include computer code disposed on a non-transitory computer-readable storage medium or a process controller that includes such a non-transitory computer-readable storage medium. The computer code may include instructions for the permeability measurement system 90 to execute one or more procedures stored in circuitry of the computing device 114. These procedures may correspond to steps associated with the process 40 or 54 for determining gas permeability.

While the disclosure may be susceptible to various modifications and alternative forms, specific embodiments have been shown by way of example in the drawings and have been described in detail herein. However, it should be understood that the embodiments provided herein are not intended to be limited to the particular forms disclosed. Rather, the various embodiments may cover all modifications, equivalents, and alternatives falling within the spirit and scope of the disclosure as defined by the following appended claims.

What is claimed is:

1. A method comprising:
supplying a gas to an upstream side of a core holder containing a core sample;
accumulating permeated gas that has flowed through the core sample in a cavity coupled to a downstream side of the core holder;
measuring an elapsed time during which the permeated gas accumulates in the cavity using a timer;
measuring a pressure of the permeated gas using a pressure transducer coupled to the cavity; and
determining a gas permeability of the core sample based at least in part on the pressure of the permeated gas and the elapsed time.

2. The method of claim 1, wherein determining the gas permeability comprises:
determining a molar quantity of the permeated gas in the cavity based at least in part on the pressure of the permeated gas;
determining a volumetric quantity of the permeated gas based at least in part on the molar quantity;
determining a volumetric flow rate of the permeated gas based at least in part on the volumetric quantity and the elapsed time; and
determining the gas permeability based at least in part on the volumetric flow rate.

3. The method of claim 2, wherein determining the molar quantity of the permeated gas comprises using the formula:
$$n = \frac{P \cdot V}{R \cdot T}$$
where n is the molar quantity, P is the pressure, R is an ideal gas constant, and T is a temperature of the permeated gas.

4. The method of claim 3, wherein determining the volumetric quantity of the permeated gas comprises using the formula:
$${V}_{m} = \frac{n \cdot R \cdot T}{{P}_{m}}$$
where Vₘ is the volumetric quantity, n is the molar quantity, R is the ideal gas constant, T is the temperature of the permeated gas, and Pₘ is a mean gas pressure determined using the formula:
$${P}_{m} = \frac{{P}_{1} + {P}_{2}}{2}$$
where Pₘ is the mean gas pressure, P₁ is a supplied pressure of the gas upstream of the core holder, and P₂ is a downstream pressure of the gas downstream of the core holder.

5. The method of claim 4, wherein determining the volumetric flow rate of the permeated gas comprises using the formula:
$$Q = \frac{{V}_{m}}{t}$$
where Q is the volumetric flow rate, Vₘ is the volumetric quantity, and t is the elapsed time.

6. The method of claim 5, wherein determining the gas permeability comprises using the formula:
$${K}_{gas} = \frac{Q \cdot μ \cdot L \cdot {P}_{a} \cdot 2}{A \cdot ( {P}_{1} - {P}_{2} ) \cdot ( {P}_{1} + {P}_{2} )}$$
where K_{gas} is the gas permeability, Q is the volumetric flow rate, μ is a viscosity of the gas, L is a length of the core sample, Pₐ is an atmospheric pressure, A is a cross-sectional area of the core sample, P₁ is the supplied pressure, and P₂ is the downstream pressure.

7. The method of claim 1, comprising venting the permeated gas from the cavity when the pressure reaches a threshold using a relief valve coupled to the cavity.

8. The method of claim 1, wherein determining the gas permeability of the core sample comprises using a computing device configured to receive a signal indicative of the pressure from the pressure transducer.

9. The method of claim 1, comprising:
obtaining the core sample from a hydrocarbon formation; and
producing hydrocarbons from the hydrocarbon formation based at least in part on the determined gas permeability of the core sample.

10. The method of claim 9, wherein producing hydrocarbons from the hydrocarbon formation comprises:
recovering hydrocarbons from the hydrocarbon deposit; and
processing the recovered hydrocarbons.

11. A system comprising:
a core holder configured to hold a core sample within the core holder; and
a measurement system coupled to a downstream side of the core holder, wherein the measurement system is configured to sense a pressure of permeated gas that has flowed through the core sample into a cavity of the measurement system, measure an elapsed time during which the permeated gas accumulates in the cavity, and determine a gas permeability of the core sample based at least in part on the pressure and the elapsed time.

12. The system of claim 11, comprising a gas supply pressure sensor configured to sense a pressure of a gas supplied to an upstream side of the core holder.

13. The system of claim 11, wherein the measurement system comprises a pressure transducer configured to sense the pressure of the permeated gas in the cavity.

14. The system of claim 11, wherein the measurement system comprises a temperature sensor configured to sense a temperature of the permeated gas in the cavity.

15. The system of claim 11, wherein the measurement system comprises a timer configured to measure the elapsed time.

16. The system of claim 11, wherein the measurement system comprises a computing device configured to determine the gas permeability of the core sample and display the gas permeability of the core sample on a display.

17. The system of claim 11, wherein the measurement system comprises a relief valve configured to vent the permeated gas from the cavity when the pressure reaches a threshold.

18. The system of claim 11, wherein the measurement system is configured to generate a report presenting at least the determined gas permeability of the core sample.

19. The system of claim 11, wherein the measurement system is configured to operate at least partially automatically.

20. A system comprising:
a cavity configured to receive permeated gas that has flowed through a core sample, wherein the cavity has a volume less than approximately 0.5 cubic centimeters;
a pressure transducer coupled to the cavity and configured to sense a pressure of permeated gas in the cavity less than approximately 1.2 kilopascals; and
a relief valve coupled to the cavity and configured to vent the permeated gas from the cavity when the pressure reaches a threshold.
